(19) United States
(12) Patent Application Publication
(10) Pub. No.: US 2005/0275351 A1
(43) Pub. Date: Dec. 15, 2005

(54) Gas discharge fluorescent device with lamp support

(76) Inventor: Shichao Ge, San Jose, CA (US)

Correspondence Address: PARSONS HSUE & DE RUNTZ LLP, 595 MARKET STREET, SUITE 1900, SAN FRANCISCO, CA, 94105, US

(21) Appl. No.: 11/055,536

(22) Filed: Feb. 9, 2005

(30) Foreign Application Priority Data
Feb. 10, 2004 (CN) 200420020038.7
Feb. 24, 2004 (CN) 200420020388.3
Jun. 21, 2004 (CN) 200420067725.4
Aug. 3, 2004 (CN) 200420081610.0
Oct. 11, 2004 (CN) 200420096486.5
Dec. 7, 2004 (CN) 200420114016.7

(51) Int. Cl. H05B 37/02

(52) U.S. Cl. 315/56; 315/291; 315/224; 315/60

(57) ABSTRACT

A cold cathode gas discharge device is disclosed comprising an elongated fluorescent lamp that is supported along its length by means of the lamp support, such as a support pole. The support provides the device with mechanical strength, so that it does not need an outer shield for protection from external forces. A driver housing attaches together the lamp support and an electrical connector to form a rigid structure, forming a sturdy unitary body.

### BACKGROUND OF THE INVENTION

This invention relates in general to gas discharge fluorescent devices, and in particular, to an improved cold cathode gas discharge fluorescent device with lamp support. Many of the features of this invention are useful for delivering higher intensity illumination. This invention may also be useful for delivering illumination in the form of small form factor lighting devices.

HCFL and CCFL employ entirely different mechanisms to generate electrons. The HCFL operates in the arc discharge region whereas the CCFL functions in the normal glow region. This is illustrated on page 339 from the book Flat Panel Displays and CRTS, edited by Lawrence E. Tannas, Jr., Von Nostrand Reinhold, New York, 1985, which is incorporated herein by reference. The HCFL functions in the arc discharge region. As shown in FIG. 10-5 on page 339 of this book, for the HCFL functioning in the arc discharge region, the current flow is of the order of 0.1 to 1 ampere. The CCFL functions in the normal glow region. Functioning in the normal glow region of the gas discharge, the current flow in the CCFL is of the order of 10⁻³ ampere, according to FIG. 10-5 on page 339 of the above-referenced book. Thus, the current flow in the HCFL is about two orders of magnitude or more than that in the CCFL. CCFL lighting devices are described, for example, in U.S. Pat. Nos. 6,211,612 and 6,515,433.

The HCFL typically employs a tungsten coil coated with an electron emission layer. For more details, see page 61 of Applied Illumination Engineering, Second Edition, Jack L. Lindsey, 1997, published by The Fairmont Press, Inc. in Lilburn, Ga. 30247, which is incorporated herein by reference. More than 1 watt of power is needed to heat the tungsten coil to about 900° C. At this temperature, the electrons can easily leave the electron emission layer and a small voltage of the order of about 10 volts will pull large currents into the discharge. The large current flow is in the form of a visible arc, so that the HCFL is also known as the arc lamp. The small voltage will also pull ions from the discharge which return to the tungsten coil, thereby ejecting secondary electrons. The lifetime of an HCFL is determined primarily by the evaporation of the electron emission layer at the high operating temperature of the HCFL.

The CCFL emits electrons by a mechanism that is entirely different from that of the HCFL. Instead of employing an electron emission layer and heating the cathode to a high temperature to make it easy for electrons to leave the cathode, the CCFL relies on a high cathode-fall voltage (about 150 V) to pull ions from the discharge. These ions eject secondary electrons from the cathode and the cathode-fall then accelerates the secondary electrons back into the discharge producing several electron-ion pairs. Ions from these pairs return to the cathode. Because of the high cathode-fall voltage (about 150 V), the ions are accelerated by the cathode-fall voltage from the discharge to the cathode, thereby causing sputtering. Different from the HCFL, no power is wasted to heat the CCFL to a high temperature before light can be generated by the lamp.

The HCFL operates at a relatively low voltage (about 100 V) whereas the CCFL operates at high voltages (of the order of several hundred volts). The HCFL operates at a temperature of about 40° C. and above, with the cathode operating at a relatively high temperature of about 900° C., whereas the CCFL operates in a temperature range of about 30-75° C., with the cathode operating at a temperature of about 80-150° C. For further information concerning the differences between HCFL and a CCFL, please see the paper entitled “Efficiency Limits for Fluorescent Lamps and Application to LCD Backlighting,” by R. Y. Pai, Journal of the SID, May 4, 1997, pp. 371-374, which is incorporated herein by reference.

HCFLs operate in the arc discharge region and generates many electrons in excited states. In a smaller diameter tubing, the mercury vapor in the tubing will absorb a higher proportion of the electrons so that the number of photons generated by the change in states of the excited electrons (to a lower state) will be reduced, resulting in a reduced generation of UV light and reduced light generation efficiency. For this reason, HCFLs typically employ large diameter tubings. For this reason, HCFLs typically have sufficient mechanical strength and do not require extra support.

Hot cathode fluorescent lamps (HCFLs) have been used for illumination. While HCFLs are able to deliver significant power, the useful life of HCFLs is typically in the range of several thousand hours. For many applications, it may be costly or inconvenient to replace HCFLs when they become defective after use. It is therefore desirable to provide illumination instruments with a longer useful life. The cold cathode fluorescent lamp (CCFL) is such a device with a useful life in the range of about 20,000 to 50,000 hours. Furthermore, the useful life of code cathode fluorescent lamps (“CCFLs”) is substantially independent of the number of times the CCFLs are turned on and off. For this reason, CCFLs have been used in place of HCFLs in many applications, including traffic lights, street lamps, lamps for outlining the silhouette of a building, flashing lights and information displays. CCFLs are also smaller than HCFLs and are therefore more versatile for many different lighting applications.

CCFLs typically comprise an elongated tube and a pair of electrodes at the two ends of the tube where the current between the electrodes in the CCFL is not more than about 5 milliamps and the power delivered by the conventional CCFLs less than about 5 watts. In order to increase the power delivered by the CCFL, it is possible to increase either the length of (and consequently, the voltage across the CCFL) or the current in the CCFL.

CCFLs are the most efficient in generating light when the inside diameter of the CCFL is of the order of 1.5 mm. For this reason, it is desirable to employ small diameter CCFLs to use power efficiently so as to reduce the amount of power consumed. One way to deliver higher intensity illumination using the CCFL is to increase the length of the CCFL. However long CCFLs with a small diameter are fragile so that CCFLs lighting devices typically employ an outer shell or container in which the CCFL is placed, in order to shield the CCFL from external forces from the environment. In other words, the outer shell or container acts as a mechanical shield for protecting the CCFL. However, when used for high intensity illumination applications, the CCFL generates considerable heat which is not easily dissipated. This is particularly the case when the CCFL is contained within an outer shell or container. This results in a temperature of the CCFL at a level much higher than the normal operating temperature range of about 30° to 75° Centigrade. This may cause the mercury vapor in the CCFL to have an elevated pressure, thereby reducing the light generating efficiency and shortens the useful life of the CCFL. For example, in a 13 watt CCFL employing the conventional design with an outer shell for the CCFL, the center part of the CCFL element may have a temperature of about 150° Centigrade. Furthermore, the heat generated by the CCFL may be transferred to the driver for driving the CCFL and shortens the useful life of the driver.

While use of the outer shell or container does protect the fragile CCFL from external forces from the environment, the outer shall does not, however, necessarily protect the CCFL from damage caused by vibrations, so that high intensity CCFL devices are frequently damaged during the handling process such as when the CCFL devices are shipped.

While CCFL lighting devices are smaller than HCFL lighting devices, it may be difficult to use the CCFL for certain lighting applications with small form factors. For example, for the form factor MR-16 reflector lamp, the lighting element has to fit within a reflector cup with a depth of smaller than 1.5 inch. Using the existing CCFL technology, it is impossible to provide a 7 watt lighting device within such a small form factor.

While the present conventional CCFL backlight may be adequate for smaller LCD screens, such as those not more than 20 inch screens, the conventional CCFL back light design is inadequate for generating higher light output for LCD screens larger than 30 inches. If one attempts to increase the brightness of the conventional CCFL back light by using longer and small diameter CCFLs for larger LCD screens, the longer CCFL tubes simply do not have adequate mechanical strength to be practical. If the diameter of the longer CCFL is increased to give it better mechanical strength, this reduces its efficiency and is also undesirable. Also, the size of the display usually limits the length of the CCFLs that can be used, especially for larger diameter CCFLs, and one cannot use CCFLs of a size longer than would fit the display size, in order to increase the CCFL power for higher intensity. The thicker CCFL may also be impractical for many applications that require the CCFL back light to fit within certain dimensions.

None of the above-described gas discharge lighting devices are entirely satisfactory. It is therefore desirable to provide an improved gas discharge device, such as a CCFL device, in which the above-described difficulties are overcome.

### SUMMARY OF THE INVENTION

In conventional CCFL designs, the CCFL is supported within the lighting device only at the two ends of the elongated lamp, so that the mechanical integrity of the CCFL relies entirely on the mechanical strength of the elongated CCFL lamp itself . . . Therefore for high intensity illumination applications where a long but narrow CCFL is employed, the CCFL becomes fragile and prone to damage. The conventional technique of protecting the CCFL from the environmental forces by an outer shell impedes heat dissipation and reduces the efficiency and useful life of the lamp. For small form factor applications, a CCFL that is supported within the device only at its two ends may also be too fragile to be practical and too short to generate the required light output. One aspect of the invention is based on the recognition that by providing external support along the length of the elongated CCFL, so that the elongated CCFL is not relying on the support that it receives at its two ends, the above-described difficulties are overcome. This may be accomplished, in one embodiment, by attaching the elongated CCFL along its length at a plurality of locations to the surface of a lamp support, so that instead of relying only on the mechanic strength of the lamp itself, the elongated CCFL now finds mechanical support through the support member. By strengthening the mechanical integrity in this manner, it is no longer necessary to protect the CCFL from the environment by the means of an outer shell or container, so that the heat generated by the CCFL may be readily dissipated. In this manner, the operating temperature of the CCFL may be lowered compared to conventional designs so that it can operate within the optimal temperature range. Since the heat generated is readily dissipated, the driver for the CCFL would also not rise significantly so that its useful life is also increased compared to conventional designs.

By providing mechanical support to the CCFL as described above, it is also possible to provide a long but narrow CCFL that would fit within small form factor illumination applications, such as that of the MR-16 reflector lamp.

In conventional CCFL designs, the shape of the light source provided by the CCFL is determined only by the shape of the CCFL itself. However, since the mechanical strength of the conventional CCFL is determined only by that of the CCFL tube itself, because of the lack of mechanical strength, the shape of the light source that can be practically formed by the conventional CCFL is rather limited. By providing a lamp support attached to and supporting the light source along its length, the shape of the light source is no longer limited by what may be mechanically feasible for a gas discharge lamp such as a CCFL without external support. It is therefore possible to provide a gas discharge light source with a wide variety of shapes compared to what is feasible with existing CCFL or HCFL devices.

A gas discharge device such as a CCFL is driven by a driver which is in turn connected to an outside power source such as a power outlet through an electrical connector . . . The driver converts the power from the power outlet into appropriate voltage and current for driving the gas discharge device such as a CCFL. To further increase the mechanical strength of the illumination device, according to another aspect of the invention, the above-described lamp support is mechanically connected to the electrical connector either directly or through a housing for the driver to form a substantially rigid structure, in an integral or unitary body.

In one embodiment, the CCFL is preferably in the shape of a spiral (e.g. single, double or multiple spirals or coils) which surrounds the lamp support. Also preferably, the lamp support is in the shape of a pole so that the CCFL wraps around the pole and is attached to the pole surface at a number of locations for increased mechanical strength.

The above described features may be used independently of one another or in any combination for various lighting applications. Compared to existing technology, the high intensity illumination applications using one or more of the above-described features provide a gas discharge lighting device with high mechanical strength, and high light generating efficiency with long useful life. The device can withstand vibrations or shock and the driver is less affected by the heat generated by the lamp itself, since the device has good heat dissipation characteristics.

### BRIEF DESCRIPTION OF THE DRAWINGS

FIG. 1 is partly cross-sectional and partly perspective view of a portion of a CCFL for illustrating one embodiment of the invention.

FIG. 2 is a partly cross-sectional and partly perspective view of one end of a CCFL to illustrate an embodiment of the invention.

FIG. 3 is a partly cross-sectional and partly perspective view of a portion of a CCFL lighting device having an electrical connector to illustrate another embodiment of the invention.

FIG. 4A is a partly cross-sectional and partly perspective view of a portion of a CCFL with a driver with housing and an electrical connector to illustrate one embodiment of the invention.

FIG. 4B is a perspective view of a CCFL device, supported by a plate shaped member, with a driver with housing and an electrical connector to illustrate another embodiment of the invention.

FIGS. 5-8 are partly cross-sectional and partly perspective views of CCFL lighting devices each with a driver, driver housing and electrical connector with a portion of the driver housing removed to illustrate yet more embodiments of the invention.

FIGS. 9-11 are partly cross-sectional and partly perspective views of CCFL lighting devices each with a CCFL, driver, driver housing and electrical connector with different shapes of lamp supports of the CCFL to illustrate different embodiments of the invention.

FIGS. 12-14B are perspective views of four different CCFL lighting devices each with CCFL, driver, driver housing, electrical connector and an outer shell or container (which may be closed or open ended) to illustrate more embodiments of the invention.

FIGS. 15A-15E are schematic views illustrating different shapes of the lamp support that can be used.

FIG. 16 is a schematic view of a LCD device using a CCFL device as back light for LCD display.

For simplicity in description, identical components are labeled by the same numerals in this application.

### DETAILED DESCRIPTION OF EXEMPLARY EMBODIMENTS

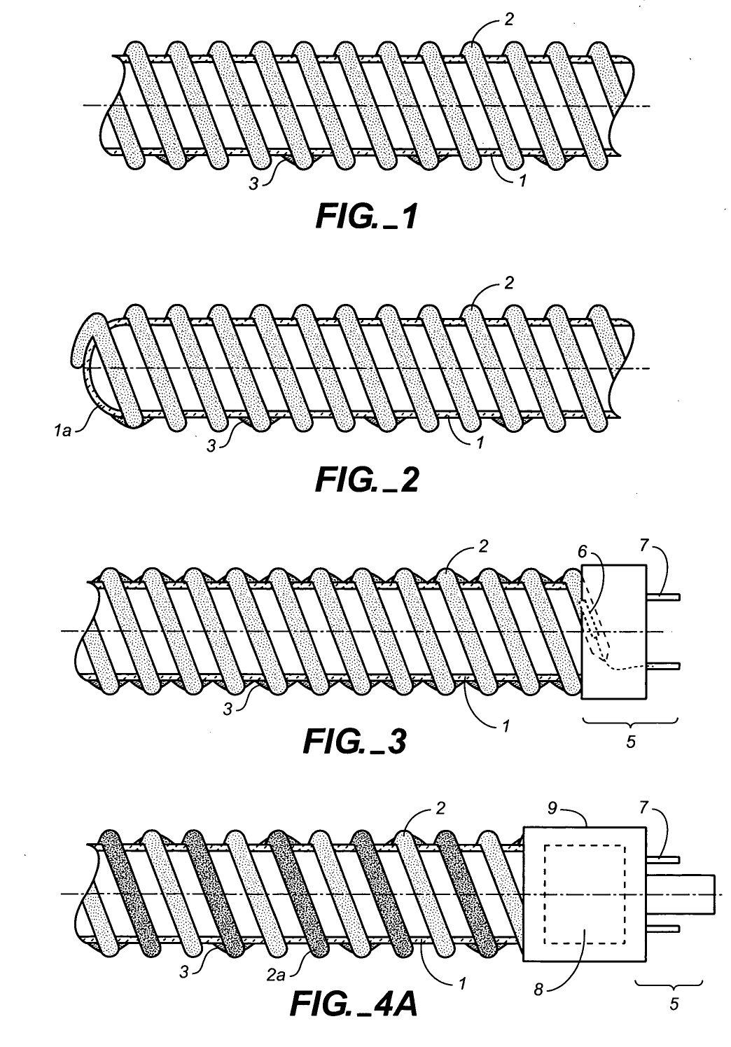

FIG. 1 is a partially cross-sectional and partially perspective view of a CCFL lighting device comprising a lamp support 1 and a CCFL 2 supported by the lamp support. As shown in FIG. 1, lamp support is in the shape of a pole and the CCFL is in the shape of a spiral wrapped around the support pole 1. The CCFL is attached to the surface of the support pole 1 by means of adhesive 3 at a number of locations along the length of the CCFL 2. The adhesive 3 may preferably be of a type that is stable and does not lose its adhesive function or expand or contract significantly to the extent that would significantly reduce the mechanical strength of the lighting device, despite exposure to heat and ultraviolet radiation. In one embodiment, adhesive 3 may be an epoxy, silicone, silicone rubber, resin or plastic type adhesive.

The support pole 1 may have a circular or elliptical cross-section and may comprise glass, plastic, ceramic or a metallic material, which may be transparent, reflective or colored. The inside or outside surface may also have a reflective layer (not shown separately in FIG. 1).

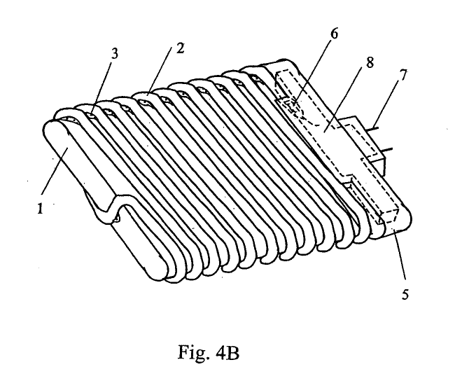

FIG. 2 is a partially cross-sectional and partially perspective view of one end of a CCFL lighting device to illustrate another embodiment of the invention. The embodiment of FIG. 2 is similar to that of FIG. 1. In addition, in the embodiment of FIG. 2, the support 1 has a round end 1a.

FIG. 3 is a partially cross-sectional and partially perspective view of a portion of a CCFL lighting device to illustrate another embodiment of the invention. As shown in FIG. 3, one end of the lamp support 1 is attached to an electrical connector 5. The electrodes 6 of the CCFL 2 are connected (only one connection shown in FIG. 3) to the two prongs 7 of the electrical connector 5. The electrical connector 5 may be one of many types of conventional electrical connectors, such as those used for incandescent lamps, and such as ones adapted for mechanical and electrical connection to conventional power outlets.

FIG. 4A is a partially cross-sectional and partially perspective view of a portion of a CCFL lighting device to illustrate one more embodiment of the invention. As shown in FIG. 4, the support 1 is attached to a housing 9 for a driver 8 contained within the housing. The driver 8 is electrically connected to the two prongs 7 of electrical connector 5 and also to electrodes (not shown) of the CCFL 2. The driver 8 converts power supplied to the prongs 7 into current and voltage suitable for operating the CCFL 2. The driver 8 may be an AC/AC or DC/AC inverter and can convert input power in the form of 100 to 250 volts at 50 or 60 hertz, AC power, or convert DC power from several to few hundred volts, into AC power suitable for operating the CCFL at high frequency and high voltage (e.g. 1 kilohertz to 800 kilohertz at several hundred to several thousand volts). The driver 8 can also include a high voltage transformer that converts a low voltage at high frequency AC power to the above described suitable high power and high frequency for operating the CCFL, where driver 8 may also additionally include an inductor and/or a fuse. The CCFL lighting device of FIG. 4A may include a CCFL 2a in addition to CCFL 2 also attached to support pole 1 by adhesive 3 at a number of locations along its length, where the locations may surround the support 1. Thus, preferably, a CCFL will wrap around the support and be attached to the support surface at a plurality of locations that surround the support to form a mechanically strong structure. This may be the case whether or not the support is in the shape of a pole or of other shapes, such as the shapes shown in this application. Also preferably, the CCFL has a spiral shape, and comprises one or more coils that surround at least a portion of the support.

FIG. 4B is a perspective view of a CCFL device, supported by a plate shaped member 1, with a driver 8 with housing and an electrical connector 5 to illustrate another embodiment of the invention. The driver 8 can be a DC/AC or AC/AC converter, or just a transformer with an optional fuse and/or inductor. The connector 7 can be one of many conventional lamp connectors. As in prior embodiments, the CCFL 2 is attached to the support 1 by means of adhesives 3 at a plurality of locations that preferably surround the support 1. FIG. 4B is an embodiment for a lamp which may be useful for desk lamp type of applications.

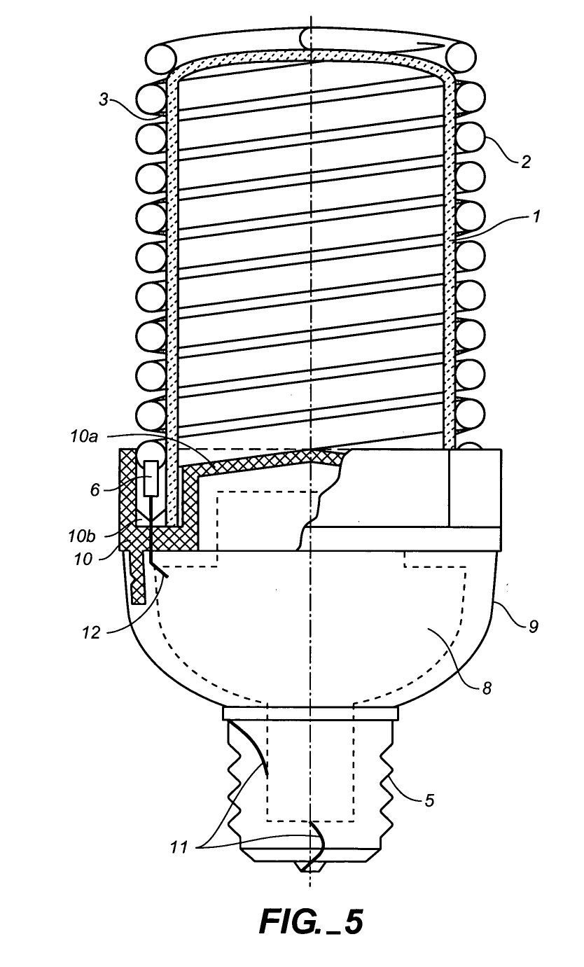

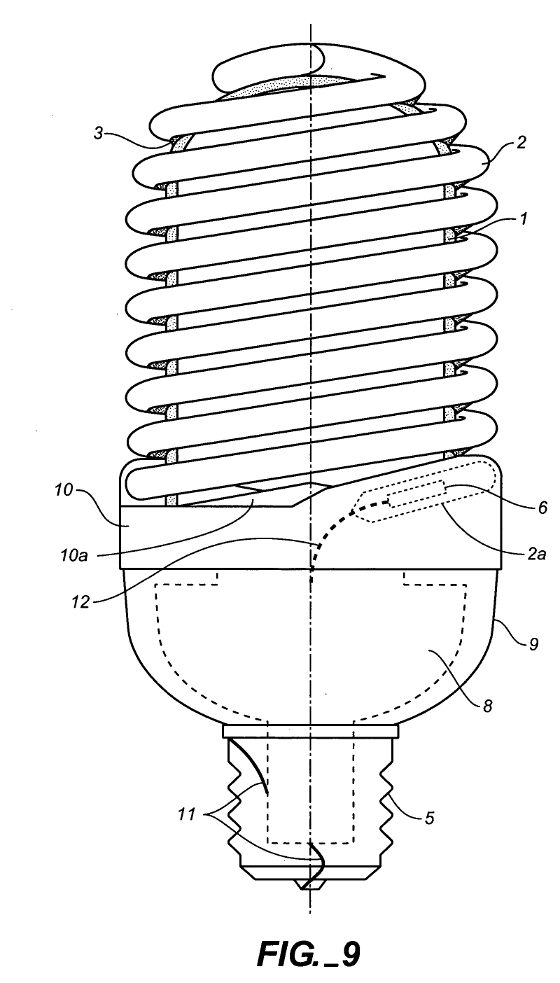

FIGS. 5-8 are partially cross-sectional and partially perspective views of different CCFL lighting devices each with at least one CCFL, at least one lamp support, a driver, a driver housing and an electrical connector with a portion of the driver housing removed to illustrate various different embodiments. Thus as shown in FIG. 5, the lamp support 1 is attached to the upper portion 10 of the driver housing 9. Top portion 10 has a groove 10b for housing electrodes 6 of the CCFL 2 to fix the position of the electrodes relative to the housing 9, with an air gap between the electrodes 6 and the main body of the housing 9. Housing 9 is in turn attached to electrical connector 5 so that housing 9, connector 5 and support 1 form substantially rigid structure for increased mechanical strength, and thereby also forming an integral or unitary body. This is true not only for the embodiments in FIGS. 5-8 but also for the embodiments in FIGS. 9-13 described below. Thus in the prior embodiments, the CCFL 2 is attached to the surface of lamp support 1 by means of adhesive 3 at a plurality of locations so that the mechanical strength of the CCFL is greatly increased and does not rely solely on the mechanical strength of the lamp itself . . . Furthermore, because of the rigid structure formed by the housing 9, connector 5 and support 1, the entire CCFL lighting device has great mechanical strength and does not require an outer shell or container for protection from external forces in the environmental. Furthermore, since no outer shell shields the CCFL, the lighting device of FIG. 5 has great heat dissipation capabilities and the heat generated by the CCFL 2 does not significantly raise the temperature of the driver 8. Furthermore, as evident from FIG. 5, electrodes 6 are separated from the driver 8 by air gap in groove 10b between the top plate portion 10 of housing 9 and electrodes 6 to further reduce the heat transfer between the CCFL and the driver housing. It is found that with designs as shown in FIGS. 5-8, an 18 watt CCFL has a temperate of 70° to 80° C. and the driver housing temperature will not be raised (due to heat transfer from the CCFL) to more than 20° C. higher than room temperature.

The top portion 10 can have a light reflective layer 10a facing the CCFL 2 to reflect light directed to the housing outwards for illumination purposes. Driver 8 may be connected through wires 11 to electrical connector 5 for connection to an outside power source (not shown). Connector 5 may be one of many different types of conventional electrical connectors.

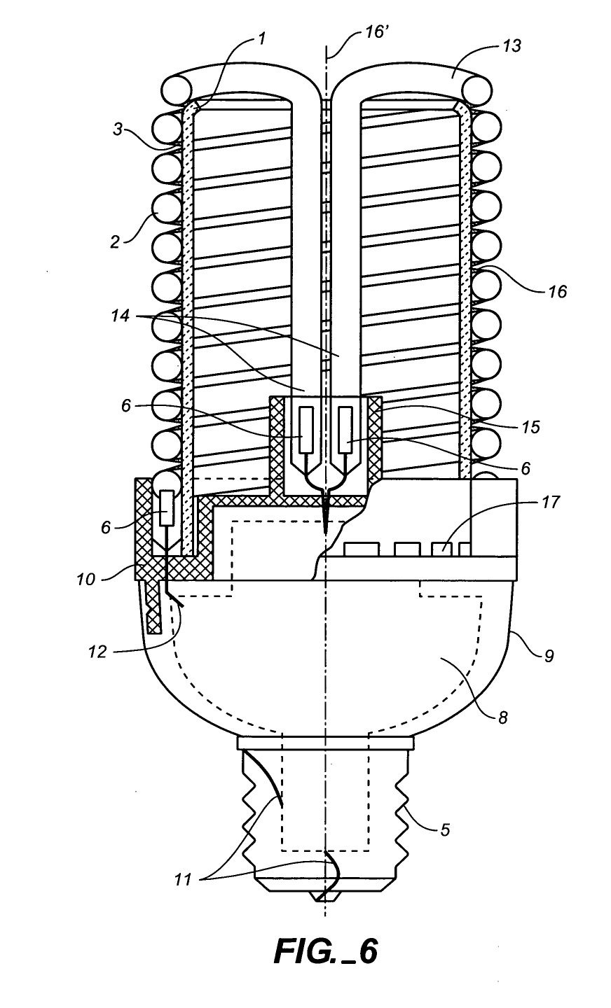

The embodiment of FIG. 6 is similar to that of FIG. 5 except that a second CCFL 13 is employed in addition to CCFL 2. One end 14 of each of the two CCFLs is attached to the top portion 10 of the housing 9 by means of fixture 15. Two CCFLs are used to increase the length of the CCFL for higher power applications within the same height limit. Alternatively, a single CCFL 13 may be used with the center portion 14 of the CCFL 13 is attached to the top portion 10 of the housing 9 by means of fixture 15. The support 1 for the CCFLs is open ended, so that one end 14 of each of the two CCFLs is placed in the support 16. The wall thickness of the CCFLs 2 and 13, may preferably be in the range of 0.2 to 3 millimeters. CCFLs with wall thicknesses in such range, coupled with the lamp support 1, have high mechanical strength and can withstand vibrations and other external forces. The open ended support 1 allows better air circulation through it and the holes 17 in the driver housing for improved heat dissipation.

The lamp support 16 may have a circular or elliptical cross-section and may comprise glass, plastic, ceramic or a metallic, material, which may be transparent, reflective or colored. The inside or outside surface may also have a reflective layer (not shown separately in FIG. 6). The support 16 may have a round end.

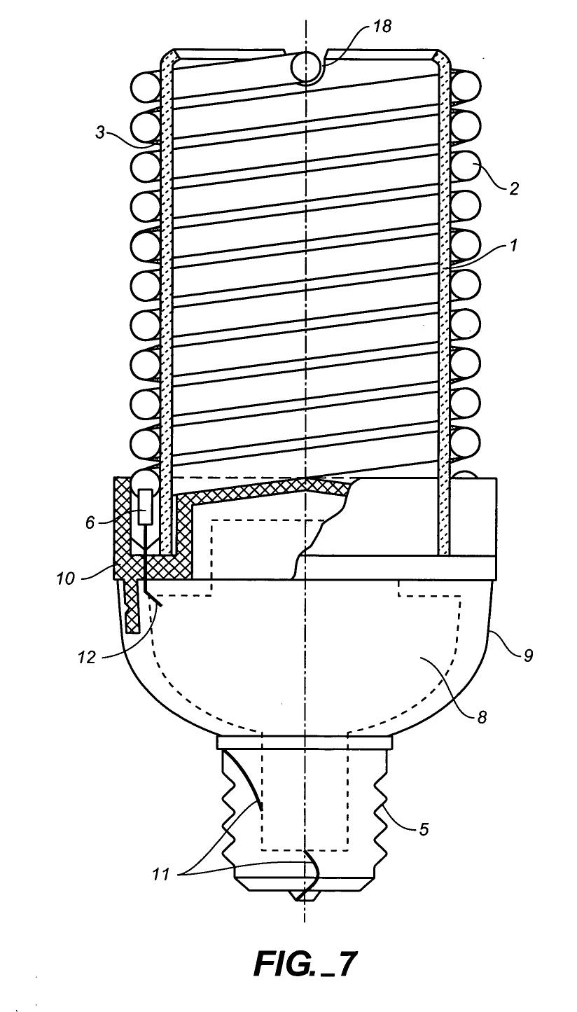

The supports 1 and 16 of FIGS. 1-6 may have a closed end top portion or may have an open end such as the support 16 shown in FIG. 6, with a portion or portions of the CCFLs placed inside the support 16 along axis 16′of the support and of the CCFL device. As shown in FIG. 6, the top portion 10 of housing 9 may also have at least one hole 17 to allow air movement for heat dissipation from the CCFL. As shown in FIG. 7, the top portion of the supports 1 can also have an indentation or groove 18 to accommodate the CCFL 2. The supports 1 and 16 may also comprise a light reflective layer at their inside or outside surfaces. The CCFLs 2 may be attached to supports 1 or 16 by means of adhesive 3. The adhesive may be of a type so that the CCFL will not break because of expansion or contraction due to the change in temperature.

FIGS. 9-11 are partially cross-sectional and partially perspective views of CCFL lighting devices to illustrate three different embodiments of the invention. In FIG. 9, the support 1 is in the form of a pole with a spherical top or end. In FIG. 9, the electrode 6 is oriented substantially along the direction of the spiral of the CCFL 2. As compared to the situation where the electrodes are aligned along the axis of the device, this arrangement allows the electrodes to be placed outside of the driver housing, so that heat generated by the electrodes can be effectively dissipated without significantly raising the temperature of the housing. As also shown in FIG. 9, the end 2a of CCFL 2 has a cross-sectional dimension which is larger than at least another portion of the CCFL (such as the portions in between the two ends), so that the two ends of the CCFL can accommodate electrodes 6 having dimensions which are larger than otherwise. This may be advantageous for generating larger currents in the CCFL and increases its useful life due to sputtering inherent in the operation of the CCFL.

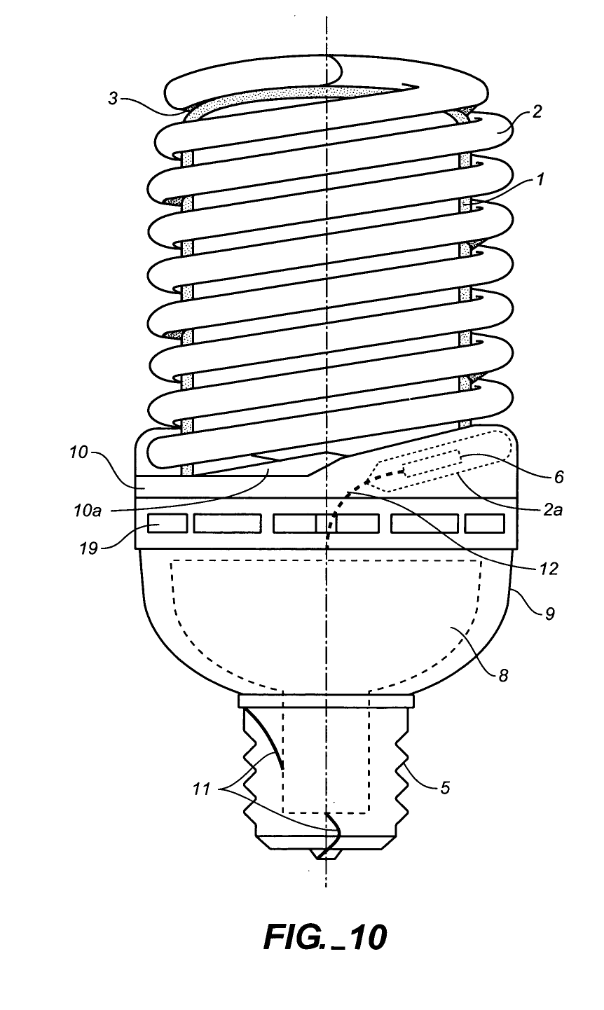

In the embodiment of FIG. 10, the CCFL 2 is separated from the housing 9 and driver 8 by an air gap 19 to reduce the extent of heat transfer from the CCFL to the driver 8, thereby reducing the temperature of the driver and increasing the useful life of the CCFL lighting device of FIG. 10.

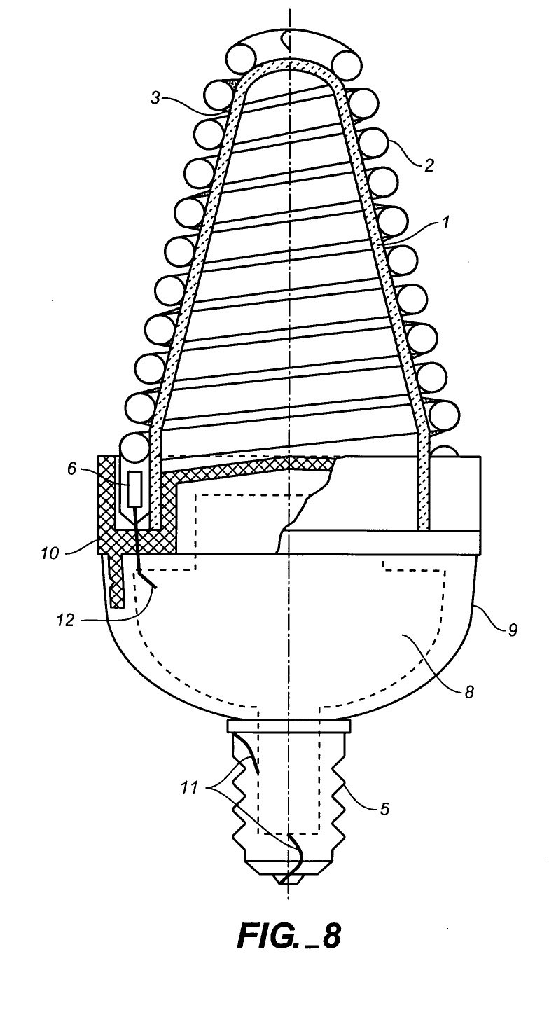

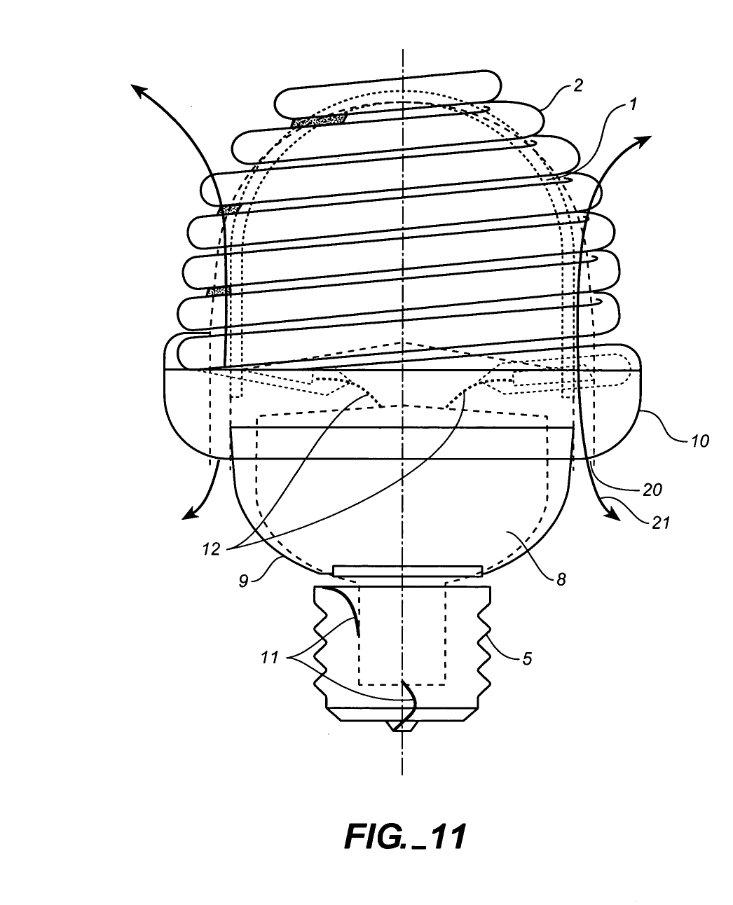

In FIG. 11, the support 1 has the shape of substantially a hemisphere (or a pole with a hemispheric end) attached to the top portion 10 of the driver housing 9. Support 1 of FIG. 11 defines holes 20 therein to facilitate air movement which facilitates dissipation of heat generated by the CCFL 2. The air movement is indicated as 21 in FIG. 11. Thus, the shape of the lamp supports 1 and 16 may be, in whole or in part, plate-shaped, spherical, hemispherical, cylindrical, pyramidal, conical, cubical, ellipsoidal in shape or in the shape of a candle-flame as illustrated in FIG. 8, and may be open or close ended.

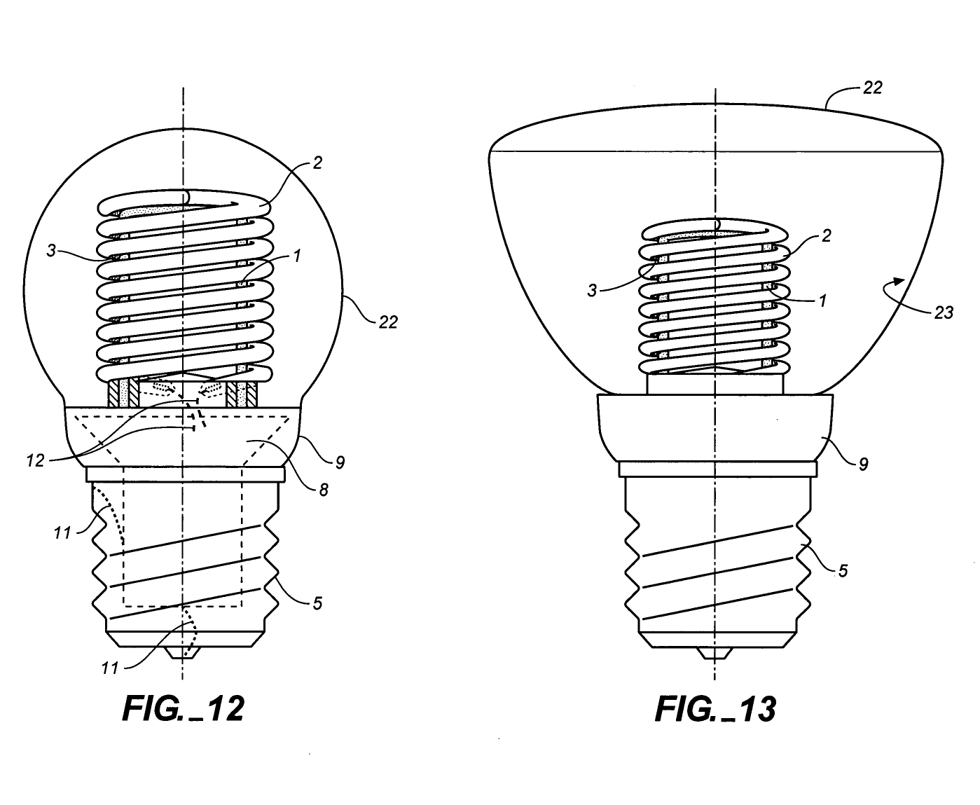

FIGS. 12-14 are perspective views of three different small CCFL lighting devices to illustrate more embodiments. Each of the embodiments comprises support 1, at least one driver 8 and housing 9, and outer shell or container 22 which transmits light, and a connector 5. The input power for the driver is transmitted through wires 11 from the connector 5 which receives power through a connection from an outside power source (not shown). The output power of driver 8 is supplied through wires 12 to the CCFL electrodes 6. As in the prior embodiments, the CCFL is attached to the surface of the support pole 1 by means of adhesive 3 at a number of locations along the length of the CCFL 2. Also as in the prior embodiments, the CCFL electrodes are separated from the driver 8 by air gaps between housing 9 and the electrodes to reduce the heat transfer between the CCFL and the driver housing and driver. Preferably, the CCFL in these embodiments has a spiral shape and emits light of at least one color. In reference to FIGS. 12 and 13, preferably housing 9 mechanically connects the lamp support, electrical connector 5 and the container 22 to form a rigid structure, and form a unitary or integral body

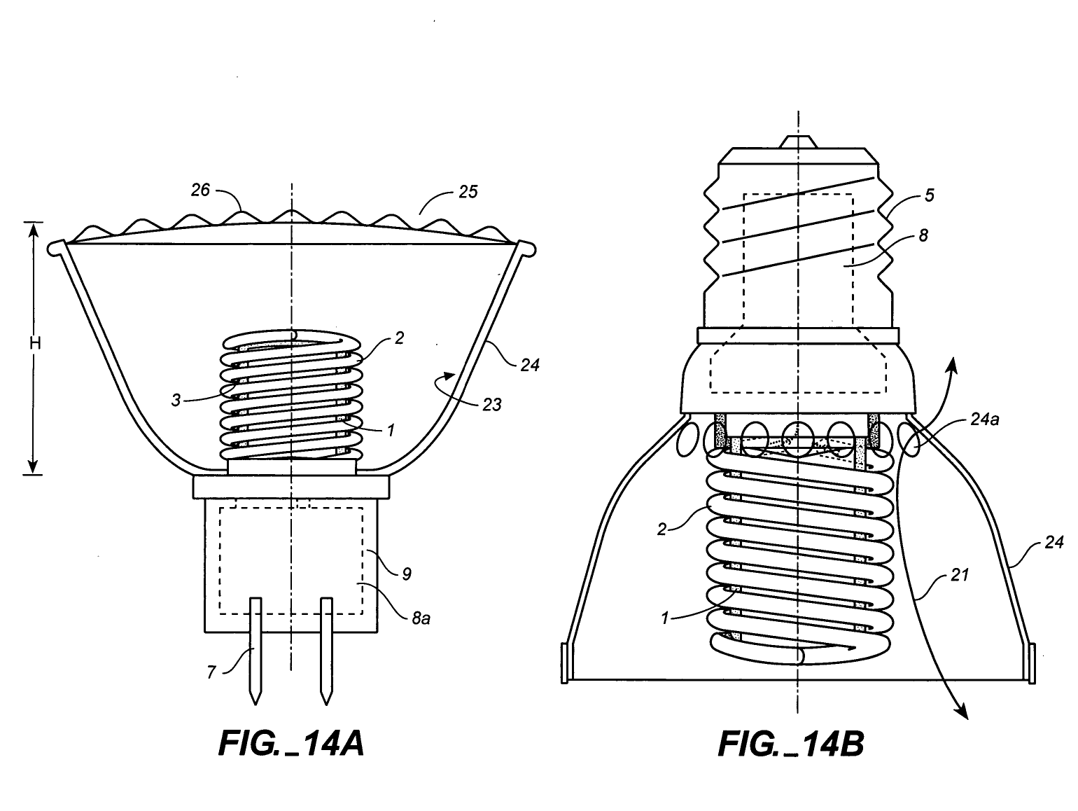

Outer shell or container 22 may be made of glass or plastic, transparent or translucent (i.e. transmits diffuse light), or may transmit light of only selected color or colors. Outer shell or container 22 may also comprise in part a reflective surface for reflector lamps, such as that shown in FIGS. 13 and 14A and 14B. For example, shell 22 has a reflective layer or surface 23 for reflecting light towards the top portion of the shell 22. Outer shell for reflector lamps can be made of glass, plastic, and metallic.

In FIG. 14A, there is no separate electrical connector connected to the driver housing 9. Instead, the two prongs 7 are connected electrically directly to the driver 8 and connected mechanically and fixed to the driver housing 9 to form a substantially rigid structure and unitary body. The prongs 7 may be similar to those of certain conventional electrical connectors, such as those used for incandescent lamps, and such as ones adapted for mechanical and electrical connection to conventional power outlets. Driver 8a may be a high voltage transformer, with an optional fuse and/or inductor where the transformer converts low voltage high frequency power received from the prongs 7 to high voltage and high frequency power suitable for operation of CCFLs. Cup 24 has a reflective surface 23 and may comprise a glass, ceramic or metallic material. The light transmitting window 25 may simply be air or a material that is transparent or one that transmits light of only selected color(s). Window 25 may also comprise a plurality of lenses 26.

In another embodiment, the CCFL device of FIG. 14B is similar to that of FIG. 14A except that there is no cover for the window 25, so that the CCFL 2 is not contained within an outer shell, where the cup 24 preferably made of a metallic light reflective material, serves only as a reflector. Cup 24 defines holes 24 a therein to enhance air movement along directions 21 so as to facilitate heat dissipation from the CCFL 2. The CCFL 2 preferably has an outside diameter of 2-3 mm, and a length of about 0.4 m to 1.6 m for a 9 watt lamp, about 0.5 m to 2 m for a 13 watt lamp and about 0.8 m to 3 m for a 18 watt lamp. The CCFL forms a coil with a diameter of about 10 mm to 30 mm for a 3 to 5 watt lamp, 10 mm⁻⁴⁰[ ]mm for a 5-9 watt lamp, 20 mm˜55 mm for a 9-13 watt lamp and 30 mm˜85 mm for a 13-18 watt lamp. The device of FIG. 14B also differs from that of FIG. 14A in that it includes a connector 5 instead of prongs 7. Both types or other types of conventional connectors can be used here for the CCFL devices in both FIGS. 14A and 14B as well as other figures of this application.

The embodiments of FIGS. 14A and 14B may be suitable for use in lamps of small form factors, such as the MR-16. Cup 24 may have a height or depth H that is not more than one or two inches, and a CCFL 2 with an outside diameter of not more than about 5 mm and a length of more than about 100 mm, such as of the order of 650 mm, may be formed in a spiral around support 1, where the CCFL 2 has sufficient length for a 7˜9 watt CCFL lamp. Such a CCFL device would still have sufficient mechanical strength for a practical lighting device, where the CCFL 2 and support 1 would fit within the short distance H, so that the devices would meet the MR-16 or other small form factor requirement, such as that for the S14, R20, G14, A14 type of conventional lamp shapes The reflector lamp R20, R30, R40 and R50 may preferably use bigger CCFL coils as it will be required to deliver higher power as the size of the lamp increases.

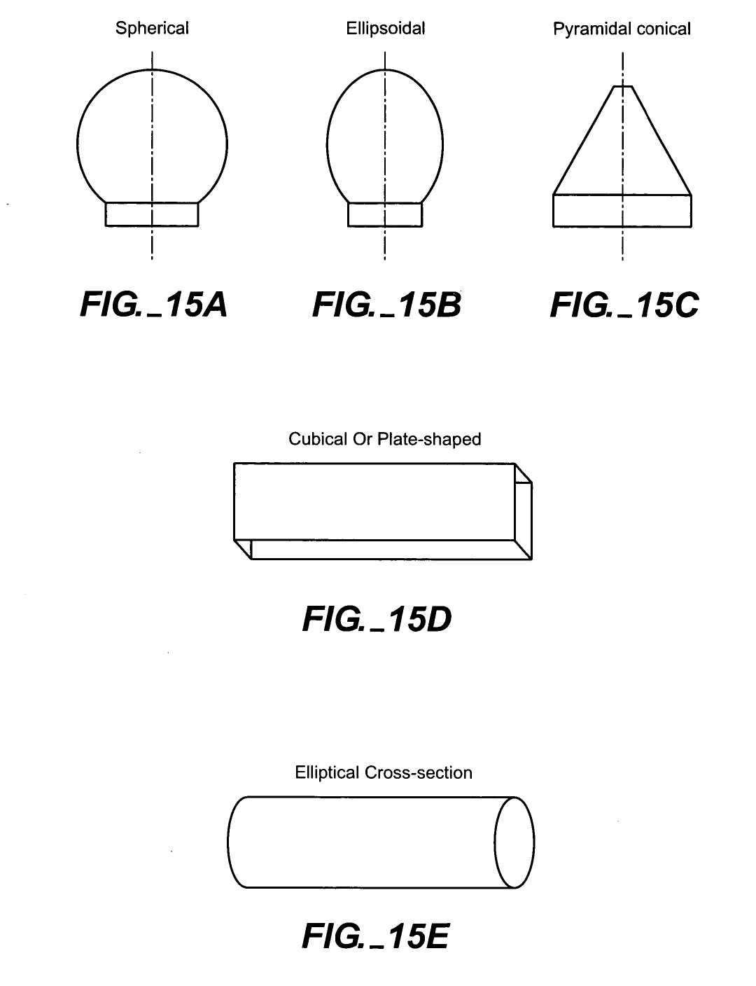

The supports 1 and 16 may assume shapes other than those described above, such as substantially spherical, one with elliptical cross-section, pyramidal, conical or ellipsoidal in shape, cubical or plate-shaped. These various shapes are illustrated in FIGS. 15A-15E. The shapes CCFLs supported by, and of the light sources formed by the CCFLs supported by, these supports may be similar to those of the supports in these figures.

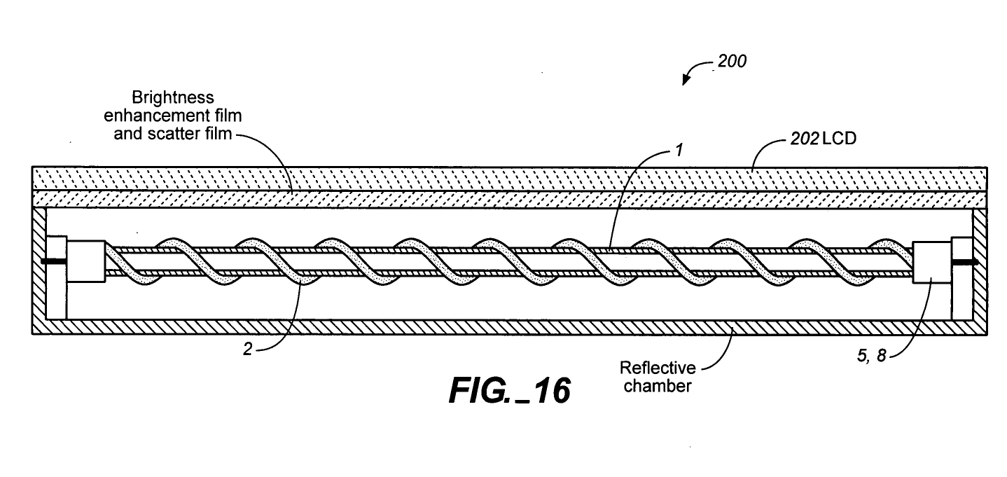

In some of the embodiments described above, where support 1 takes the shape of a pole, the CCFL device may be made to fit the form factors of the T-5, T-8, T-12 and other conventional shapes of fluorescent lamps. In some of the embodiments described above, where support 1 takes the shape of a pole, the CCFL device may be used as back light for LCD and other displays. This is illustrated in FIG. 16. As shown in FIG. 16, the LCD device 200 comprises an LCD layer 202, and a CCFL back light comprising a plurality of CCFLs 2 each supported by a lamp support pole 1 and driven by driver 8. While the present conventional CCFL backlight may be adequate for smaller LCD screens, such as those not more than 20 inch screens, the conventional CCFL back light design is inadequate for generating higher light output for LCD screens larger than 30 inches. For such larger screen LCD displays, such as those used for large screen televisions, the embodiment shown in FIG. 16 is appropriate. Using CCFLs of outside diameters in a range of 2 mm to 8 mm, and a length of not less than about 0.5 m, the design in some of the embodiments of this application is quite adequate for large screen LCD displays.

While the invention has been described above by reference to various embodiments, it will be understood that changes and modifications may be made without departing from the scope of the invention, which is to be defined only by the appended claims and their equivalents. For example, some of the features herein such as lamp support may also be useful for certain hot cathode gas discharge fluorescent applications, such as for high power applications (e.g. delivering over 50 watts). All references referred to herein are incorporated herein by reference in their entireties.

1. A cold cathode gas discharge device, said device comprising:
a light source comprising at least one cold cathode fluorescent lamp having an elongated shape for supplying light;
a lamp support pole having a surface, wherein said cold cathode fluorescent lamp is attached to the surface at a plurality of locations along its length so that the lamp is substantially fixed in position relative to the surface; and
an electrical connector electrically connected to the lamp and supplying power to the lamp.

2. The device of claim 1, said at least one lamp having a spiral shape.

3. The device of claim 2, said at least one lamp being in the shape of one or more coils.

4. The device of claim 2, said at least one lamp surrounding the lamp support pole.

5. The device of claim 2, said at least one lamp having two ends and two electrodes at its two ends, said electrodes oriented along direction of the spiral shape of the at least one lamp.

6. The device of claim 2, said device having an axis, said at least one lamp having two ends and two electrodes at its two ends, said electrodes oriented along the axis of the device.

7. The device of claim 1, said at least one lamp having two ends and two electrodes at its two ends, said two ends having cross sectional dimensions that are larger than at least another portion of the at least one lamp to accommodate electrodes that are larger than the dimensions of such portion.

8. The device of claim 1, said lamp support pole having a shape that is substantially spherical, hemi-spherical, cylindrical, pyramidal, conical, cubical, ellipsoidal in shape or in the shape of a candle-flame or plate, an elongated stem with a round end or one having an elliptical or circular cross section.

9. The device of claim 1, wherein said lamp support pole comprises a glass, plastic, ceramic or metallic material.

10. The device of claim 1, further comprising an adhesive attaching said at least one cold cathode fluorescent lamp to the surface at a plurality of locations along its length, said adhesive comprising a material that is stable and retains its function as an adhesive when exposed to UV radiation or heat.

11. The device of claim 1, wherein said at least one cold cathode fluorescent lamp comprises an envelope having a wall that is about 0.2 to 3 mm in thickness.

12. The device of claim 1, wherein said lamp support comprises an elongated pole, and said at least one lamp surrounds said pole, said lamp support and said at least one lamp forming a straight cold cathode lamp.

13. The device of claim 1, wherein said lamp driver includes an AC/AC or DC/AC inverter.

14. The device of claim 1, wherein said lamp driver includes a high voltage transformer, and/or a fuse and/or an inductor.

15. A cold cathode gas discharge device, said device comprising:
a light source comprising at least one cold cathode fluorescent lamp for supplying light;
a lamp support having a surface, wherein said at least one cold cathode fluorescent lamp is attached to the surface at a plurality of locations along its length so that the lamp is substantially fixed in position relative to the surface; and
a driver supplying power to the at least one lamp to cause it to emit light;
an electrical connector electrically connected to the driver supplying power to the driver; and
a housing for the driver, said housing mechanically connecting the lamp support and the connector to form a substantially rigid structure.

16. The device of claim 15, wherein said at least one cold cathode fluorescent lamp is an elongated and having a shape that matches said surface of the lamp support.

17. The device of claim 15, wherein said lamp support comprises a pole.

18. The device of claim 15, wherein said lamp support has a groove or indentation which is shaped to accommodate said at least one lamp.

19. The device of claim 15, wherein said lamp support has an open or closed end.

20. The device of claim 15, wherein said lamp support comprises a glass, plastic, ceramic or metallic material.

21. The device of claim 15, wherein said housing comprises a reflective layer facing the at least one lamp.

22. The device of claim 15, wherein said at least one lamp is separated from said driver and housing by an air gap to reduce heat transfer from said at least one lamp to said driver.

23. The device of claim 15, wherein said housing having a wall facing said at least one lamp, said wall having one or more holes therein to facilitate air movement for removing heat generated by said at least one lamp.

24. The device of claim 15, further comprising an adhesive attaching said at least one cold cathode fluorescent lamp to the surface at a plurality of locations along its length, said adhesive comprising a material that is stable and retains its function as an adhesive when exposed to UV radiation or heat.

25. The device of claim 15, wherein said lamp support comprises an elongated pole, and said at least one lamp surrounds said pole, said lamp support and said at least one lamp forming a straight cold cathode lamp.

26. The device of claim 15, wherein said lamp driver includes an AC/AC or DC/AC inverter.

27. The device of claim 15, wherein said lamp driver includes a high voltage transformer, and/or a fuse and/or an inductor.

28. A cold cathode gas discharge device, said device comprising:
a light source comprising at least one cold cathode fluorescent lamp for supplying light;
a lamp support having a surface, wherein said at least one cold cathode fluorescent lamp is attached to the surface at a plurality of locations along its length so that the lamp is substantially fixed in position relative to the surface; and
a driver supplying power to the at least one lamp to cause it to emit light;
an electrical connector electrically connected to the driver supplying power to the driver;
a housing for the driver; and
a container containing said at least one lamp, said housing mechanically connecting the lamp support, the container and the connector to form a substantially rigid structure.

29. The device of claim 28, wherein said container comprises glass or plastic, has a shape of a conventional lamp, and is translucent or transparent to light from said at least one lamp.

30. The device of claim 28, wherein said container passes only light of a selected color from said at least one lamp.

31. The device of claim 28, wherein said housing comprises a reflective layer facing the at least one lamp.

32. The device of claim 28, wherein said container is close ended and totally encloses the cold cathode fluorescent lamp.

33. The device of claim 28, wherein said container is open ended and does not totally enclose the cold cathode fluorescent lamp.

34. The device of claim 28, wherein said container comprises a reflective layer that conforms to shape of a conventional MR-16, R20, R24, R30, R40 or R50 type reflector lamp.

35. The device of claim 28, wherein said container comprises a reflective layer that has holes therein for air to pass through to help heat dissipation of the lamp.

36. The device of claim 28, wherein said container comprises a glass, plastic or metallic material.

37. The device of claim 28, wherein said driver includes an AC/AC or DC/AC inverter.

38. The device of claim 28, wherein said driver includes a high voltage transformer, and/or a fuse and/or an inductor.

39. A cold cathode gas discharge device, said device comprising:
a light source comprising at least one cold cathode fluorescent lamp having a predetermined shape for supplying light;
a lamp support attached to and supporting the cold cathode fluorescent lamp so that the cold cathode fluorescent lamp has said predetermined shape; and
an electrical connector electrically connected to the lamp and supplying power to the lamp.

40. The device of claim 39, said electrical connector mechanically connected to the lamp support to form a substantially rigid structure.

41. The device of claim 39, further comprising:
a driver supplying power to the at least one cold cathode fluorescent lamp to cause it to emit light; and
a housing for the driver, said housing mechanically connecting the lamp support and the connector to form a substantially rigid structure.

42. The device of claim 39, said lamp being elongated, said device further comprising an adhesive attaching said at least one cold cathode fluorescent lamp to the surface at a plurality of locations along its length, said adhesive comprising a material that is stable and retains its function as an adhesive when exposed to UV radiation or heat.

43. The device of claim 42, said plurality of locations surrounding the lamp support so that the light source has said predetermined shape.

44. The device of claim 39, said lamp being in the shape of a coil that surrounds the lamp support.

45. The device of claim 39, wherein said predetermined shape for supplying light is substantially spherical, hemi-spherical, spiral, cylindrical, pyramidal, conical, cubical, ellipsoidal in shape or in the shape of a candle-flame or plate.

46. The device of claim 39, wherein said driver includes an AC/AC or DC/AC inverter.

47. The device of claim 39, wherein said driver includes a high voltage transformer, and/or a fuse and/or an inductor.

48. The device of claim 39, said device having a predetermined shape, the lamp support attached to and supporting the light source at a plurality of locations surrounding the lamp support so that the light source has said predetermined shape.
